(19) United States
(12) Patent Application Publication
(10) Pub. No.: US 2010/0100451 A1
(43) Pub. Date: Apr. 22, 2010

(54) STREAMING SERVICE SERVER AND STREAMING SERVICE SYSTEM

(76) Inventors: Jong-Tack Kim, Gwaank-gu (KR); Sae-Woong Bahk, Seocho-gu (KR); Young-Han Kim, Seocho-gu (KR)

Correspondence Address: SHERR & VAUGHN, PLLC, 620 HERNDON PARKWAY, SUITE 320, HERNDON, VA, 20170, US

(21) Appl. No.: 12/252,822

(22) Filed: Oct. 16, 2008

(51) Int. Cl. G06Q 30/00; G06Q 50/00

(52) U.S. Cl. 705/26

(57) ABSTRACT

A streaming service server includes means for bidding prices from a plurality of super peers and means for determining at least of the plurality of the super peers based on the received bidding prices such that for a given streaming service, a total number of consumers serviced by the plurality of the super peers satisfies a predetermined criterion. Therefore, the streaming service server may determine at least one super peer in a consideration with the number of consumers served by a plurality of super peers for a given service.

### BACKGROUND

1. Technical Field

This application relates to a streaming service server and a streaming service system.

2. Description of Related Art

A streaming service system employing a peer to peer method may include a server, a super peer and a peer (i.e., leaf node). A super peer transmits streaming data received from the server to the peer. For example, a streaming service may include a broadcasting service.

When the server provides the same streaming service regardless of a contribution of the super peer, the super peer may intend to receive the streaming service with as little contribution as possible. For example, when the same streaming service is provided to a first super peer having 100 peers and a second super peer having 10 peers, the second super peer may have more satisfaction.

### SUMMARY

In some embodiments, an auction method includes receiving bidding prices from a plurality of bidders and determining at least of the plurality of the bidders based on the received bidding prices such that for a given service, a total number of consumers served by the plurality of the bidders satisfies a predetermined criterion.

Each of the plurality of the bidders may correspond to a super peer and each of the consumers may correspond to a leaf node.

The predetermined criterion may correspond to a first criterion reaching a maximum number of the consumers or a second criterion determined based on a ratio of a total number of consumers.

Determining at least of the plurality of the bidders may include determining at least first bidder of the plurality of the bidders, the at least first bidder satisfying the first criterion and determining at least second bidder of the at least first bidder, the at least second bidder satisfying the second criterion. The bidding prices may be determined by the number of the consumers served by the plurality of the bidders.

The auction method may be used for determining streaming service quality of a super peer.

In some embodiments, a streaming service server includes means for bidding prices from a plurality of super peers and means for determining at least of the plurality of the super peers based on the received bidding prices such that for a given streaming service, a total number of consumers served by the plurality of the super peers satisfies a predetermined criterion.

The predetermined criterion may correspond to a first criterion reaching a maximum number of the consumers or a second criterion determined based on a ratio of a total number of consumers.

Determining at least of the plurality of the super peers may include determining at least first super peer of the plurality of the super peers, the at least first super peer satisfying the first criterion and determining at least second super peer of the at least first super peer, the at least second super peer satisfying the second criterion.

The bidding prices may be determined by the number of the consumers served by the plurality of the super peers.

In some embodiments, a streaming service system includes a plurality of leaf nodes, a plurality of super peers configured to respectively provide a streaming service to at least of the plurality of the leaf nodes and configured to respectively offer a bidding price corresponding to a number of the at least of the plurality of the leaf nodes for determining streaming service quality and a streaming service server configured to determine at least of the plurality of the super peers based on the received bidding price such that for a given streaming service, a total number of the leaf nodes served by the plurality of the super peers satisfies a predetermined criterion.

### BRIEF DESCRIPTION OF THE DRAWINGS

FIG. 1 is a diagram for illustrating a streaming service system according to an example embodiment of the described technology.

FIG. 2 is a block diagram for illustrating a streaming service system in FIG. 1.

FIG. 3 is a flowchart for illustrating an operation of a streaming service system in FIG. 1.

FIG. 4 is a table for illustrating an auction method used in a streaming service system.

FIG. 5 is a diagram for illustrating a heuristic algorithm for obtaining an optimum number of a successful bidder.

FIG. 6 is a diagram for illustrating an operation of a heuristic algorithm in FIG. 5.

### DETAILED DESCRIPTION

The technology is described more fully hereinafter with reference to the accompanying drawings, in which example embodiments of the technology are illustrated. The technology may, however, be embodied in many different forms and should not be construed as limited to the example embodiments set forth herein. Rather, these example embodiments are provided to fully enable those of ordinary skill in the art to embody and practice the technology.

Terms used herein are to be understood as described below.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element.

The term “and/or” includes any and all combinations of one or more of the associated listed items. For example, “a first item, a second item and/or a third item” denotes at least one of the first item, the second item and the third item, that is, all the combinations of the first, second and third items including the first item, the second item and the third item each.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements, e.g., “between” versus “directly between” and “adjacent” versus “directly adjacent”, should be interpreted in a like fashion.

As used herein, the singular forms “a”, “an” and “the” are intended to include the plural forms as well, unless the context clearly indicates otherwise. It will be further understood that the terms “comprises”, “comprising”, “includes” and/or “including” when used herein, specify the presence of stated features, integers, steps, operations, elements and/or components, but do not preclude the presence or addition of one or more other features, integers, steps, operations, elements, components and/or groups thereof.

Respective steps described herein may be performed in a different order than that which is explicitly described. In other words, the respective steps may be performed in the same order as described, simultaneously, or in a reverse order.

Unless defined otherwise, all terms used herein have the same meaning as commonly understood by those of skill in the art. Such terms as those defined in a generally used dictionary are to be interpreted to have the meanings equal to the contextual meanings in the relevant field of art, and are not to be interpreted to have ideal or excessively formal meanings unless clearly defined in the present specification.

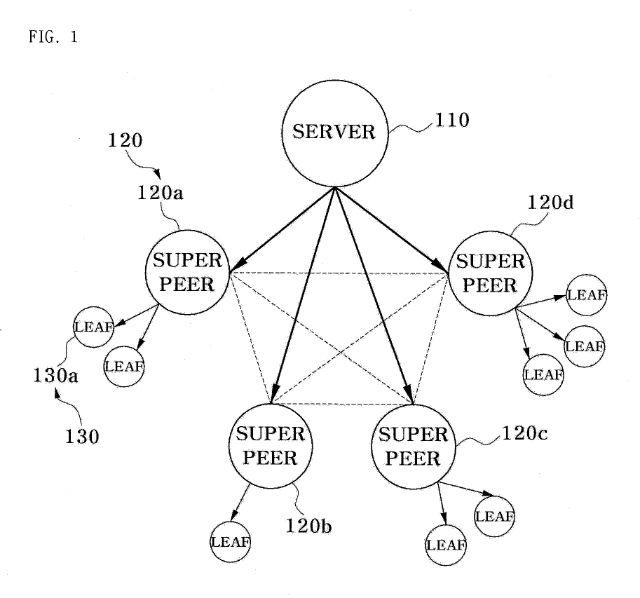

FIG. 1 is a diagram for illustrating a streaming service system according to an example embodiment of the described technology.

Referring to FIG. 1, the streaming service system 100 includes a streaming service server 110, a super peer 120 and a leaf node 130 (i.e., peer).

The streaming service server 110 provides a streaming service and intends to service as many leaf nodes possible. That is because the number of leaf nodes using the streaming service may relate to advantages including an advertisement income.

The streaming service server 110 receives help from the super peer 120 because the streaming service server 110 has a limit to the serviceable number of leaf nodes with an available bandwidth. That the super peer 120 serves as many leaf nodes as possible with super peer's available bandwidth is beneficial to the streaming service server 110. Therefore, the streaming service server 110 may determine streaming service quality of the super peer 120 according to the number of leaf nodes served by the super peer 120.

The super peer 120 may be advantageous according as the streaming service quality becomes better. The super peer 120 serving the smaller number of leaf nodes may be advantageous when the streaming service quality is equal. Therefore, when the streaming service quality of the super peer 120 is determined according to the number of the leaf nodes, the super peer 120 intends to serve as many leaf nodes as possible.

In one embodiment, the streaming service system 100 may adopt MDC(Multiple Description Coding) method for determining the streaming service quality. In the MDC method, for encoding, video data with a bitrate R may be divided M descriptions with a bitrate R/M and each of the M descriptions are encoded. For decoding, the video data are decoded by using any m description(s) (1<=m<=M). According as m becomes larger, a distortion may be smaller and the video quality may be better.

The leaf node 130 may receive a list of adequate super peers from the streaming service server 110 and may select one or more among the adequate super peers based on an RTT(Round Trip Time). The leaf node 130 may receive streaming service from the selected super peer(s).

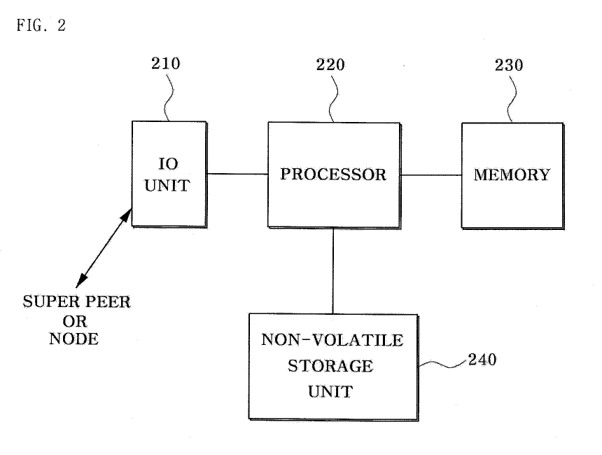

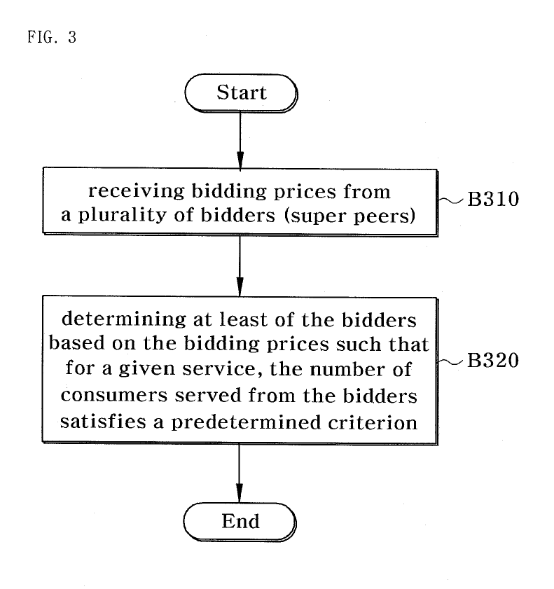

FIG. 2 is a block diagram for illustrating a streaming service system in FIG. 1 and FIG. 3 is a flowchart for illustrating an operation of a streaming service system in FIG. 1.

Referring to FIG. 2, the streaming service server 110 includes an IO unit 210, a processor 220, a memory 230 and a nonvolatile storage unit 140.

The IO unit 210 provides an input and output interface for communicating the super peer 120 or the leaf node 130. In one embodiment, the IO unit 210 may include wired network interface such as IEEE 802.11. In another embodiment, the IO unit 210 may include wireless network interface such as WiBro (Wireless Broadband).

The processor 220 controls an entire operation of the streaming service server 110. In one embodiment, the processor 220 may be configured with a single core. In another embodiment, the processor 220 may be configured with multi cores.

The memory 230 is used for storing data necessary when the IO unit 210 or the processor 220 operates. In one embodiment, the memory 230 may be volatile.

The nonvolatile storage unit 240 may be used for storing contents for the streaming service. In one embodiment, the nonvolatile storage unit 240 may correspond to a hard disk (HD) or static storage device (SSD).

In FIG. 3, the streaming service server 110 receives bidding prices from a plurality of bidders (block B310). That is, the streaming service server 110 receives bidding prices from a plurality of super peers 120. For example, the streaming service server 110 may receive bidding prices from a first through fourth super peers 120a through 120d. In one embodiment, the bidding prices may be determined by consumers (i.e., leaf nodes) served by the bidders (i.e., super peers).

The streaming service server 110 determines at least of the plurality of the bidders based on the received bidding prices such that for a given service, a total number of consumers served by the plurality of the bidders satisfies a predetermined criterion (block B320). That is, the streaming service server 110 determines at least of the plurality of the super peers 120 based on the received bidding prices such that for a given streaming service, a total number of consumers served by the plurality of the super peers 120 satisfies a predetermined criterion.

In one embodiment, the bidding prices may be determined by the consumers served by the plurality of the bidders. That is, the bidding prices may be consumers served by the plurality of the super peers 120. Each of the consumers corresponds to the leaf node 130.

The streaming service server 110 may periodically perform the auction procedure (blocks B310 through B320).

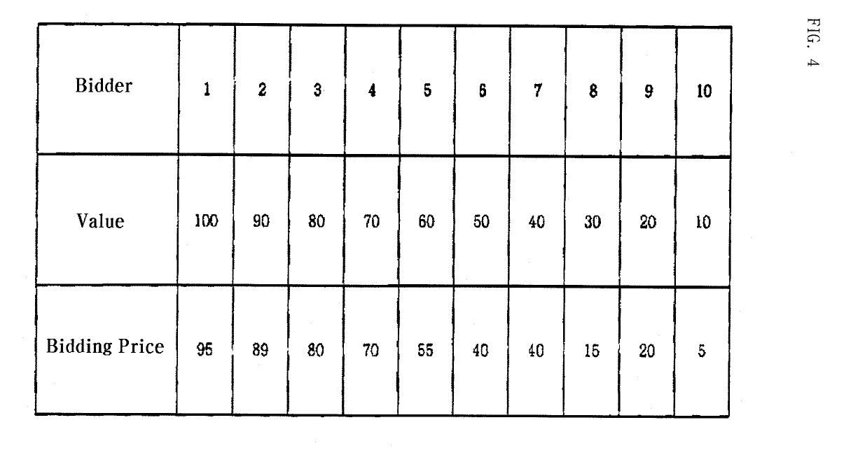

FIG. 4 is a table for illustrating an auction method used in a streaming service system.

The auction method may be classified into a highest price auction method and a second highest price auction method. In the highest price auction method, a person who bids the highest price for auction goods takes the goods. In the second highest price auction method, a person who bids the second highest price for auction goods takes the goods. That is, in the second highest price auction method, successful bidders may be determined by the bidding prices and a contract price may be determined by other bidder(s).

For example, in FIG. 4, in the highest price auction method, a first bidder 1 takes goods with the highest price of 95, but in the second highest price auction method, the first bidder 1 takes goods with the second highest price of 89.

The auction method used in the streaming service server 110 in FIG. 3 expands the concept of the second highest price auction method so that the number of the consumers served by the plurality of the bidders satisfies the predetermined criterion. That is, the streaming service server 110 adopts the auction method of n successful bidders and (n+1)st bidding price. For example, in FIG. 4, when the auction method of 3 successful bidders and 4st bidding price is adopted, the 3 successful bidders take goods with a price of 70. The auction method of n successful bidders and (n+1)st bidding price may help to determine at least one super peer 120 (i.e., successful bidder) so that an entire leaf node 130 served by the at least one super peer 120 may be maximized.

To determine the at least super peer 120 (i.e., successful bidder) so that the entire leaf node 130 may be maximized may be 110 may be advantageous to the streaming service server 110. When successful bidders of the streaming service Qⱼ corresponds to wⱼ, a contract price corresponds to pⱼ, M corresponds to a grade of the streaming service quality provided from the streaming service server 110, and N corresponds to the number of the super peer 120, the solution of the following mathematics equation (w_{M}, . . . , w₁) may correspond to the optimum number of the successful bidders.

$$Maximize {\sum }_{j = 1}^{M} {w}_{j} {p}_{j} subject to {\sum }_{j = 1}^{M} {w}_{j} = N ( {w}_{j} \geq 1 )$$

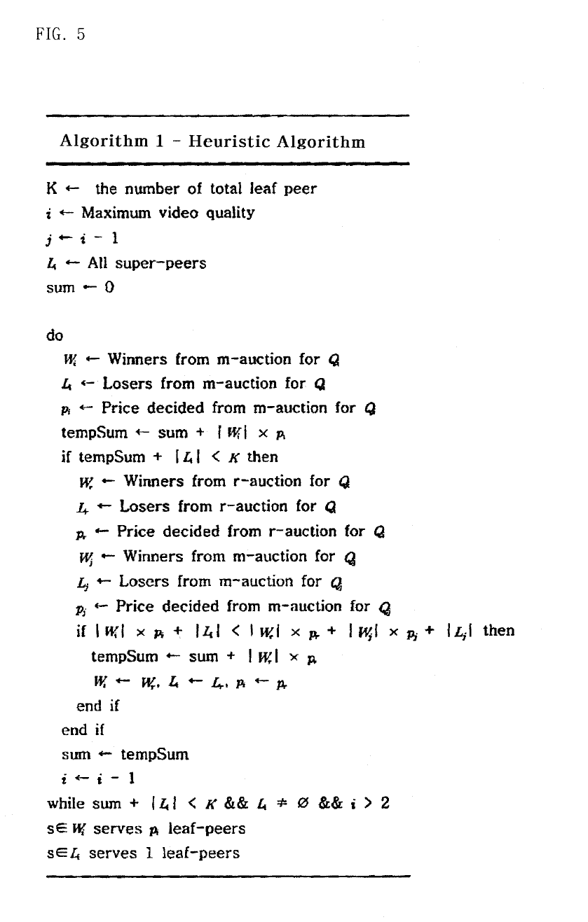

FIG. 5 is a diagram for illustrating a heuristic algorithm for obtaining an optimum number of a successful bidder.

The algorithm in FIG. 5 may be used for reducing a complexity for obtaining the optimum solution. The m-auction and r-auction in FIG. 5 presents the predetermined criterion for the number of the consumers.

The m-auction corresponds to a first criterion for determining super peers so that for a given streaming service Qⱼ, the number of leaf nodes is maximized. The r-auction corresponds to a second criterion for determining super peers with the top r percent of all bidding super peers for a given streaming service Qⱼ. The m-auction may be used for determining the maximum number of leaf nodes for the given streaming service Qⱼ but because the given streaming service Qⱼ may be determined with a relatively low price, the r-auction may be used together.

The algorithm in FIG. 5 determines the optimum solution with a consideration of the first and second criteria (i.e., the m-auction and r-auction). That is, when the streaming service Qⱼ is sold by auction, the streaming service server 110 obtains the number of leaf nodes in a case when the m-auction is used (hereinafter, referred to as the first number of leaf nodes) and the number of leaf nodes in a case when the r-auction is used (hereinafter, referred to as the second number of leaf nodes). Also, the streaming service server 110 obtains the number of leaf nodes in a case when the streaming service Qⱼ₋₁ is sold by auction and the m-auction is used (hereinafter, referred to as the third number of leaf nodes).

The streaming service server 110 adds the second number of leaf nodes and the third number of leaf nodes to obtain the fourth number of leaf nodes, and compares the first number of leaf nodes with the fourth number of leaf nodes to select the maximum between the first number of leaf nodes and the fourth number of leaf nodes.

The streaming service server 110 repeats the above procedures for all streaming services Qⱼ (1<=j<=M). The complexity of the algorithm in FIG. 5 corresponds to O(N²M).

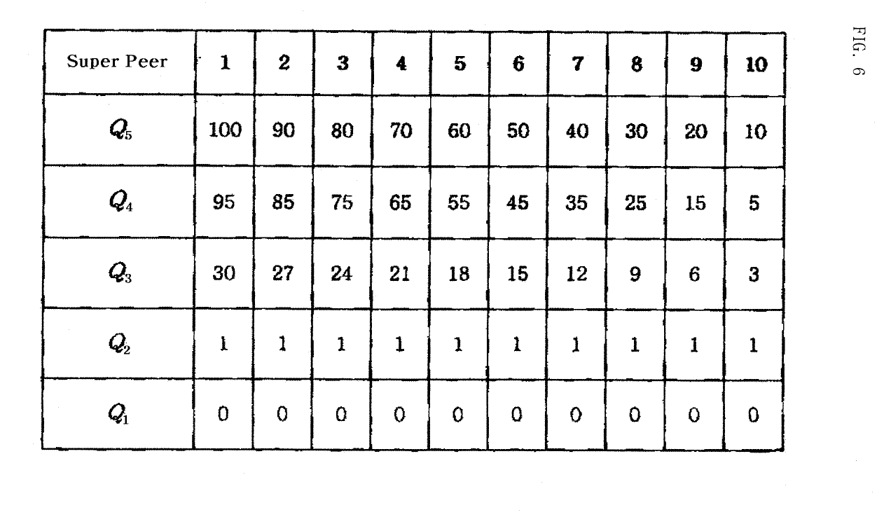

Hereinafter, an operation method of the algorithm will be described with FIG. 6.

FIG. 6 is a diagram for illustrating an operation of a heuristic algorithm in FIG. 5.

FIG. 6 assumes that the number of bidders (i.e., super peers) corresponds to 10 and a grade N of streaming service quality provided from the streaming service server 110 corresponds to 5.

In FIG. 6, in a streaming service Q₅, the number of leaf nodes is maximum when the number of super peers corresponds to 5. This is because bidding prices presented by super peers are determined by the number of leaf nodes and the number of leaf nodes corresponds to 250 (i.e., 5*50). In the streaming service Q₅, bids for 5 super peers 1 through 5 are successful with a price of 50 and 255 leaf nodes (i.e., 5*50+5*1 nodes) are served when the m-auction is used. In the streaming service Q₅, a bid for one super peer 1 is successful with a price of 90 when the r-auction is used and in the streaming service Q₄, bids for 4 super peers 2 through 5 are successful when the m-auction is used. Therefore, 275 leaf nodes (i.e., 1*90+4*45+5*1 leaf nodes) are served. As a result, the streaming service Q₅ is sold to one super peer 1 with a price of 90.

In a streaming service Q₄, 185 leaf nodes (i.e., 4*45+5*1 leaf nodes) are successful when the m-auction is used and 127 leaf nodes (i.e., 1*75+4*12+4*1 leaf nodes) are successful when the r-auction is used. As a result, the streaming service Q₄ is sold to 4 super peers 2 through 5 with a price of 45.

The above-described example embodiments may have effects including the following advantages. However, not all of the example embodiments necessarily include all the advantages, and some example embodiments may have additional advantages. Thus, the scope of the present invention is not limited by the described advantages.

An auction method according to an example embodiment of the described technology may determine at least one bidder in a consideration with the number of consumers served by a plurality of bidders for a given service. In one embodiment, the auction method may be used for determining streaming service quality of a super peer.

A streaming service server according to an example embodiment of the described technology may determine at least one super peer in a consideration with the number of consumers served by a plurality of super peers for a given service. Therefore, the streaming service server may provide differentiated streaming service according to a contribution of a super peer.

It will be apparent to those skilled in the art that various modifications can be made to the above example embodiments without departing from the spirit and scope of the invention defined by the appended claims and their equivalents.

1-11. (canceled)

12. A method comprising:
receiving bidding prices from a plurality of bidders; and
selecting at least one of said plurality of bidders based on the received bidding prices such that for a given service a total number of consumers served by the plurality of the bidders satisfies a predetermined condition.

13. The method of claim 12, wherein each of the plurality of the bidders corresponds to a super peer and each of the consumers corresponds to a leaf node.

14. The method of claim 12, wherein the predetermined condition corresponds to a first condition reaching a maximum number of the consumers or a second condition determined based on a ratio of a total number of consumers.

15. The method of claim 14, wherein said determining at least of the plurality of the bidders comprises:
determining at least one first bidder of the plurality of the bidders that satisfies the first condition; and
determining at least one second bidder of the at least one first bidder that satisfies the second condition.

16. The method of claim 12, wherein the bidding prices are determined by the number of the consumers served by the plurality of the bidders.

17. The method of claim 12, wherein the auction method is used to determine streaming service quality of a super peer.

18. An apparatus comprising a streaming service server, wherein the streaming service server is configured to:
bid prices from a plurality of super peers; and
determine at least one of the plurality of super peers based on received bidding prices such that for a given streaming service a total number of consumers served by the plurality of super peers satisfies a predetermined condition.

19. The apparatus of claim 18, wherein the predetermined condition corresponds to a first condition reaching a maximum number of the consumers or a second condition determined based on a ratio of a total number of consumers.

20. The apparatus of claim 19, wherein the apparatus is configured to determine said at least one of the plurality of the super peers by:
determining at least one first super peer of the plurality of the super peers, wherein the at least one first super peer satisfies the first condition; and
determining at least one second super peer of the at least one first super peer, wherein the at least one second super peer satisfies the second condition.

21. The apparatus of claim 18, wherein the bidding prices are determined by the number of the consumers served by the plurality of the super peers.

22. An apparatus comprising a streaming service system, wherein the streaming service system comprises:
a plurality of leaf nodes;
a plurality of super peers configured to respectively provide a streaming service to at least one of the plurality of the leaf nodes and configured to offer a bidding price corresponding to a number of the at least of the plurality of the leaf nodes for determining streaming service quality; and
a streaming service server configured to determine at least one of the plurality of the super peers based on the received bidding price such that for a given streaming service a total number of the leaf nodes served by the plurality of the super peers satisfies a predetermined condition.
